(19) United States
(12) Patent Application Publication
(10) Pub. No.: US 2026/0168591 A1
(43) Pub. Date: Jun. 18, 2026

(54) MULTI-WAY VALVE FOR CONTROLLING A FLOW OF A FLUID

(71) Applicant: VOLKSWAGEN AKTIENGESELLSCHAFT, Wolfsburg (DE)

(72) Inventors: Oliver Tappe, Cremlingen (DE); Andreas Mann, Vordorf OT Rethen (DE); Branislav Zlatkov, Braunschweig (DE); Marc Rüggeberg, Braunschweig (DE); Ralf Lüders, Peine (DE); Rika Berger, Braunschweig (DE); Felix Ehrhardt, Goslar (DE)

(21) Appl. No.: 19/126,016

(22) PCT Filed: Feb. 5, 2024
(86) PCT No.: PCT/EP2024/052777

§ 371 Date: Apr. 30, 2025

(30) Foreign Application Priority Data
Feb. 16, 2023 (DE) 10 2023 201 344.4

(51) Int. Cl. F16K 31/06; F16K 5/04

(52) U.S. Cl. CPC F16K 31/0668; F16K 5/0464; F16K 5/0471

(57) ABSTRACT

A multi-way valve for controlling a flow of a fluid includes: a valve housing forming a housing space with a central axis; at least three separate connection openings which are oriented towards the central axis and/or a central region of the housing space; and a rotary slide valve to be inserted in the housing space and to be rotated about the central axis. The rotary slide valve can set a state in which at least two connection openings are communicatively connected while simultaneously at least one connection opening is closed relative to the communicatively connected connection openings, and a state that is different therefrom. The rotary slide valve has a slide valve body and a sealing surface made from a softer material than the slide valve body.

The invention relates to a multi-way valve for controlling a flow of a fluid according to claim 1.

The invention relates to a multi-way valve for controlling a flow of a fluid, having
a valve housing in which a housing space with a central axis is formed;
at least three separate connection openings which are orientated from the central axis and/or a central region of the housing space;
a rotary slide valve which can be inserted in the housing space and can be rotated about the central axis,
   wherein by means of the rotary slide valve at least one state in which at least two connection openings are connected in communication and at the same time at least one connection opening is closed relative to the connection openings which are connected in communication and a different state can be adjusted.

Multi-way valves for distributing and/or controlling fluids are known from the prior art. The development of thermal management components of a central cooling system is currently the focus for various vehicle units.

DE 10 2016 116 550 A1 discloses a rotary slide valve with a compact sealing element of a rotary sliding valve for a motor vehicle cooling circuit in which the sealing element is formed as a coherent separate element with a complementary curvature and is inserted in the housing of the rotary sliding valve.

DE 10 2014 207 675 A1 discloses a valve arrangement having an electrically driven rotary slide valve, wherein two step motors which are permanently in rotary engagement are provided. Consequently, a static seal which is fixed to the housing cover is intended to be used.

DE 10 2014 003 802 B4 discloses a multi-way valve for a tubular passage in which a single inlet opening with a plurality of outlet openings which branch radially outward can be controlled by means of a valve closure member which can be rotated in the passage. In one embodiment, an outlet opening is surrounded by an annular seal which is fitted to the distributor housing or to the valve closure member. Such an annular seal is formed in accordance with the Figure therein by a plurality of O-rings.

DE 2 136 857 OS discloses a rotary sliding valve for lines of flowing media, in particular liquids, for example, hydrocarbons, and a seal for this, wherein in a multi-component rotary slide valve a sealing ring is clamped and pretensioned against a corresponding sealing face.

An object of the invention is to develop a cooling medium distributor module which compared with previously known multi-way valves has a good compactness, fewer components, whilst maintaining the currently conventional functions. At the same time, cost advantages and reliable technology should be achieved.

According to claim 1, the above object is achieved by the rotary slide valve having a sliding member and at least one sealing face, wherein the sealing face is formed from a softer material than the sliding member.

Advantageous further developments of the invention are characterized in the dependent claims.

According to a first embodiment of the invention, it is proposed that the multi-way valve has the following:
a valve housing in which a housing space having a central axis is formed;
at least three connection openings which are orientated separately from the central axis and/or a central region of the housing space;
a rotary slide valve which can be inserted in the housing space and can be rotated about the central axis,
   wherein by means of the rotary slide valve at least one state in which at least two connection openings are connected in communication and at the same time at least one connection opening is closed relative to the connection openings which are connected in communication and a different state can be adjusted.

According to claim 1, the above object is achieved by the rotary slide valve having a sliding member and at least one sealing face, wherein the sealing face is formed from a softer material than the sliding member.

According to another embodiment of the invention, by means of the rotary slide valve at least one state in which all the connection openings are closed or there is no fluidic connection between two connection openings can be adjusted.

According to another embodiment of the invention, by means of the rotary slide valve at least one state in which at least or precisely two connection openings are connected in communication, for example, as an inlet, to another connection opening, for example, as an outlet or vice versa can be adjusted.

According to another embodiment of the invention, by means of the rotary slide valve at least one state in which at least two connection openings are connected to each other in communication and at least two additional or other connection openings are connected to each other in communication can be adjusted.

According to another embodiment of the invention, the soft material of the sealing face being used for sealing in the multi-way valve can be deformed by a corresponding counter-face of the valve housing or the housing space, in a resilient manner, preferably in a rubber-resilient manner.

According to another embodiment of the invention, in each state the sliding member is with the sealing face thereof in the region of the connection openings in maximum force-transmitting, preferably touching, contact with the valve housing.

According to another embodiment of the invention, in each state the sliding member, with the exception of the sealing face thereof, exclusively with a bearing device is in force-transmitting, preferably touching, contact with the valve housing.

According to another embodiment of the invention, in each state the sliding member, with the exception of the sealing face thereof and where applicable with the optionally separate bearing device thereof, is free from force-transmitting, preferably free from touching contact with the valve housing.

According to another embodiment of the invention, the valve housing has in the region of the connection openings in each case a projection which is directed toward the central axis and/or the central region of the valve housing.

According to another embodiment of the invention, the housing space is narrowed inward by a projection, wherein there is formed by this projection a region in which at least one connection opening is formed.

According to another embodiment of the invention, a projection is formed with a face which is rounded in the direction toward the central axis, preferably a concentric curved segment face, wherein this rounded face forms a complementary counter-face for the at least one sealing face of the sliding member.

According to another embodiment of the invention, the at least one sealing face can be brought into sealing, preferably touching contact exclusively with a complementary counter-face which is formed by such a projection.

According to another embodiment of the invention, the sealing face is, outside of contact with a complementary counter-face, which is preferably formed by such a projection, free from contact with the valve housing.

According to another embodiment of the invention, the valve housing has a pot and a cover, wherein the rotary slide valve can be introduced for assembly in a linear manner into the pot.

According to another embodiment of the invention, the rotary slide valve can be introduced into the pot for assembly axially with respect to its own rotation axis and/or concentrically with respect to the central axis.

According to another embodiment of the invention, at least two separate throughflow channels are formed in the rotary slide valve.

According to another embodiment of the invention, at least two separate throughflow channels are permanently fluidically separated from each other by means of a partition wall of the rotary slide valve.

According to another embodiment of the invention, the at least two separate throughflow channels are in at least one state both open for communicating connection of in each case two, preferably different, connection openings.

According to another embodiment of the invention, by means of at least one throughflow channel a fluid from two connection openings can be mixed in another connection opening.

According to another embodiment of the invention, by means of at least one throughflow channel a fluid from at least one connection opening can be divided over at least two other connection openings.

According to another embodiment of the invention, by means of at least one throughflow channel a fluid from at least two connection openings can be mixed or divided over at least two other connection openings.

According to another embodiment of the invention, the connection openings are arranged cylindrically with respect to the central axis of the valve housing and spaced apart from each other at an angle in the rotation direction.

According to another embodiment of the invention, the connection openings are arranged in a circular and/or concentric manner with respect to the central axis of the valve housing.

According to another embodiment of the invention, the connection openings are arranged in an oval and/or concentric manner with respect to the central axis of the valve housing.

According to another embodiment of the invention, the sealing faces of the sliding member are arranged cylindrically with respect to the central axis of the valve housing.

According to another embodiment of the invention, the sealing faces of the sliding member are arranged in a circular and/or concentric manner with respect to the central axis of the valve housing.

According to another embodiment of the invention, the sealing faces of the sliding member are arranged in an oval and/or concentric manner with respect to the central axis of the valve housing.

According to another embodiment of the invention, the sealing faces of the sliding member are arranged in a free form with respect to the central axis of the valve housing.

According to another embodiment of the invention, the sealing faces and the counter-faces are arranged so as to complement each other in such a manner that at a specific angle a desired state can be adjusted.

According to another embodiment of the invention, exclusively pairs of sealing faces and complementary counter-faces are formed, wherein by means of other sealing faces and complementary counter-faces no pairing can be formed for sealing, that is to say no complementary sealing pair is formed by such a sealing face and counter-face.

According to another embodiment of the invention, at least one of the sealing faces has a size and arrangement so that at least one of the connection openings can be closed with this one sealing face alone.

According to another embodiment of the invention, a single connection opening can be closed exclusively by means of two sealing faces of the sliding member, that is to say a fluidic connection to another connection opening can be prevented.

According to another embodiment of the invention, the sealing face is axially higher and/or wider in the rotation direction than the complementary counter-face of the respective connection opening.

According to another embodiment of the invention, the complementary counter-face of the respective connection opening is axially higher and/or wider in the rotation direction than at least one, preferably all of the sealing faces.

According to another embodiment of the invention, the sliding member of the rotary slide valve and the valve housing are formed from the same material.

According to another embodiment of the invention, the sliding member and/or the valve housing are formed from a metal, preferably a steel alloy or aluminum alloy.

According to another embodiment of the invention, the sliding member and/or the valve housing are formed from a plastics material, preferably a reinforced plastics material.

According to another embodiment of the invention, at least one contact face, preferably the entire material, of the valve housing is formed from the same, preferably identical, material as the material of the sliding member with the exception of the sealing face.

According to another embodiment of the invention, the sliding member and the sealing face are formed from the same plastics material, wherein the sealing face comprises another softening component, for example, an elastomer material and/or softener, and/or the sliding member comprises another hardening component, for example, a duromer, a non-plastics material and/or a fiber material.

According to another embodiment of the invention, the softer material of the at least one sealing face of the rotary slide valve is formed from a rubber-resilient material.

According to another embodiment of the invention, the softer material is a thermoplastic, an elastomer material or a thermoplastic elastomer material [TPE].

According to another embodiment of the invention, the harder material of the rotary slide valve and/or the valve housing is a thermoplastic, a duromer and/or a reinforced plastics material.

According to another embodiment of the invention, the rotary slide valve is injection-molded, and the material of the sliding member is formed from a first plastics material component and the material of the sealing face is formed from a second plastics material component.

According to another embodiment of the invention, the material of the second plastics material component is softer than the material of the first plastics material component.

According to another embodiment of the invention, the material of the first plastics material component is identical to the material of the second plastics material component, wherein a then reinforcing aggregate is added at least to the first plastics material component.

According to another embodiment of the invention, the material of the sealing face is connected to the sliding member by means of positive-locking connection, non-positive-locking connection, adhesive bonding, welding, spraying on and/or vulcanization.

According to another embodiment of the invention, the sliding member of the rotary slide valve is formed from a metal, wherein the material of the sealing face is connected to the sliding member by means of positive-locking connection, non-positive-locking connection, adhesive bonding, spraying on and/or vulcanization.

According to another embodiment of the invention, the sliding member of the rotary slide valve is injection-molded and the sealing face is connected as a material placed in the injection-molding mold in a materially engaging and/or positive-locking manner to the sliding member by means of the injection process, preferably so as to be able to be released in a non-destructive manner.

Exemplary embodiments of the invention will be explained in greater detail below with reference to the drawings, in which:

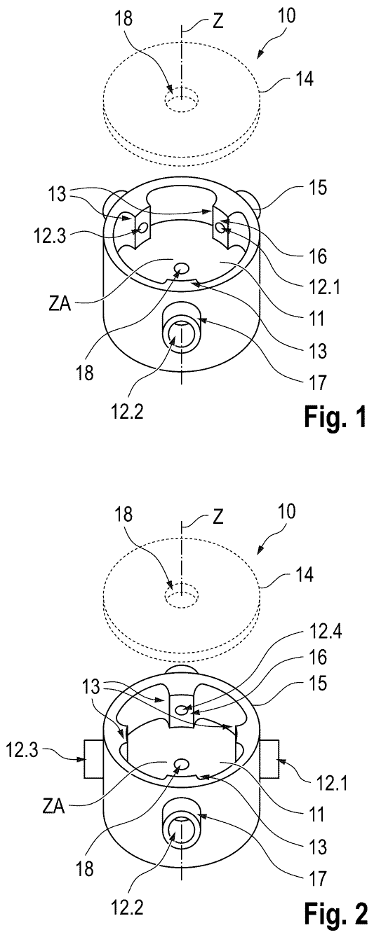

FIG. 1: shows a spatial view of a valve housing having three connection openings,

FIG. 2: shows a spatial view of a valve housing having four connection openings,

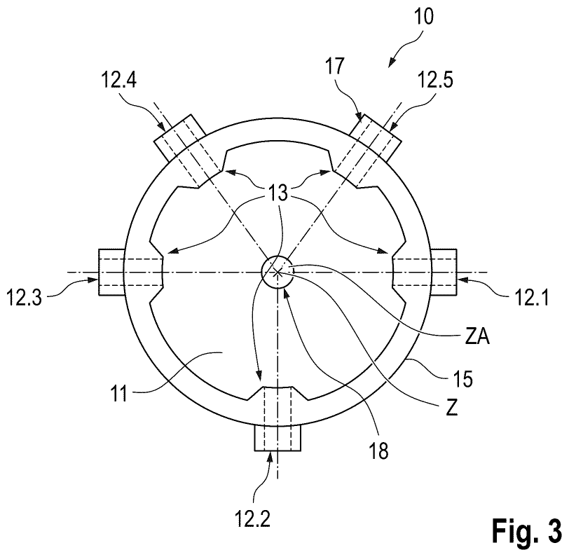

FIG. 3: shows a plan view of a valve housing having five connection openings,

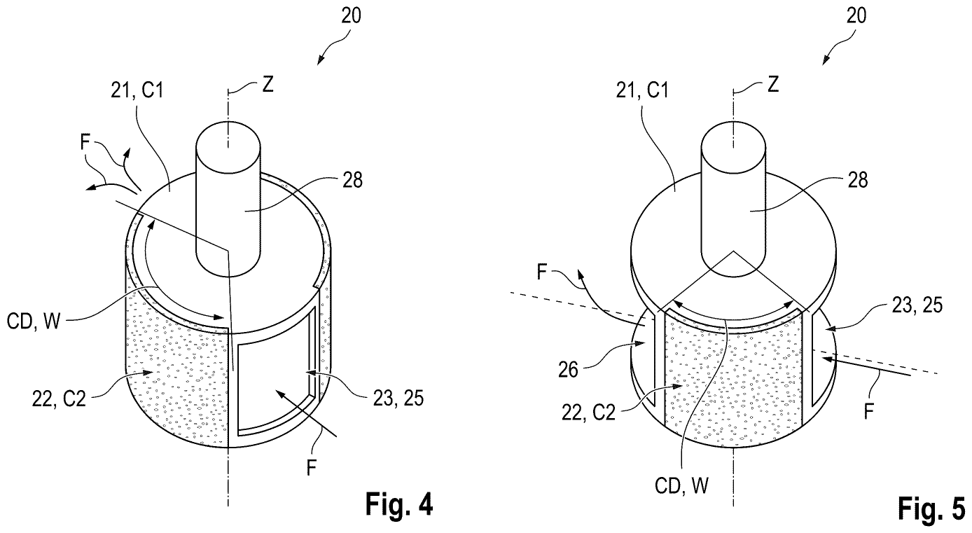

FIG. 4: shows a spatial view of a rotary slide valve having a closure angle of 120°,

FIG. 5: shows a spatial view of a rotary slide valve having a closure angle of 90°,

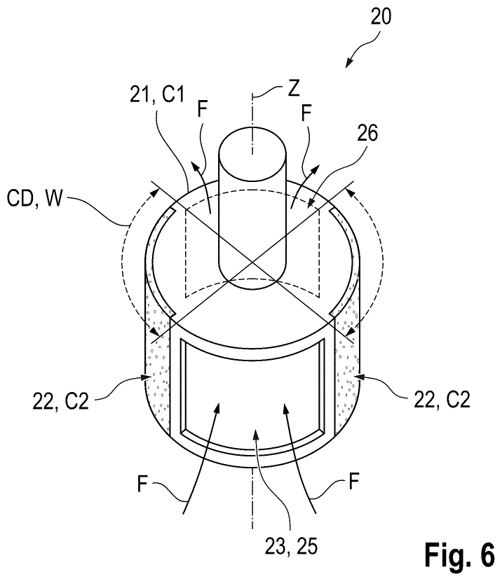

FIG. 6: shows a spatial view of the rotary slide valve according to FIG. 5 rotated through 90°,

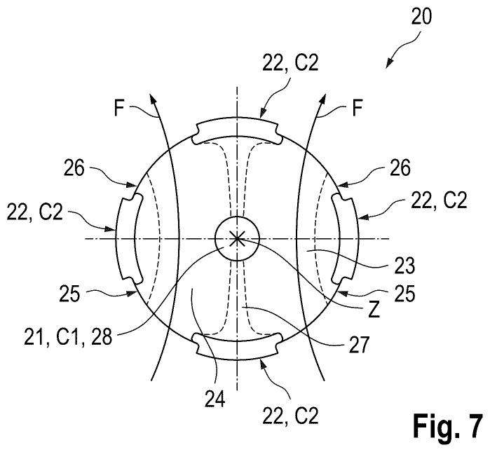

FIG. 7: shows a plan view of a rotary slide valve having two throughflow channels,

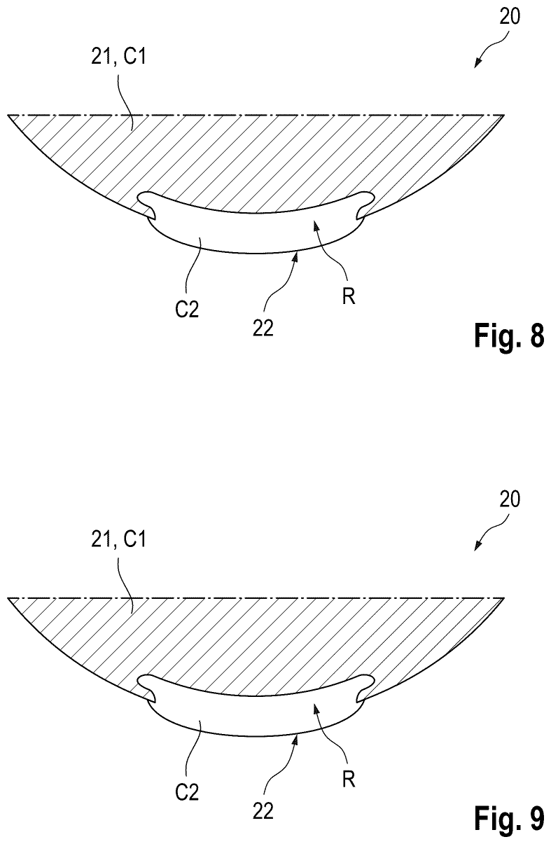

FIG. 8: shows a schematic view of a portion of a base face of a rotary slide valve with material of the sealing face connected in a non-positive-locking manner,

FIG. 9: shows a schematic view of a portion of a base face of a rotary slide valve with material of the sealing face connected in a positive-locking and/or materially engaging manner,

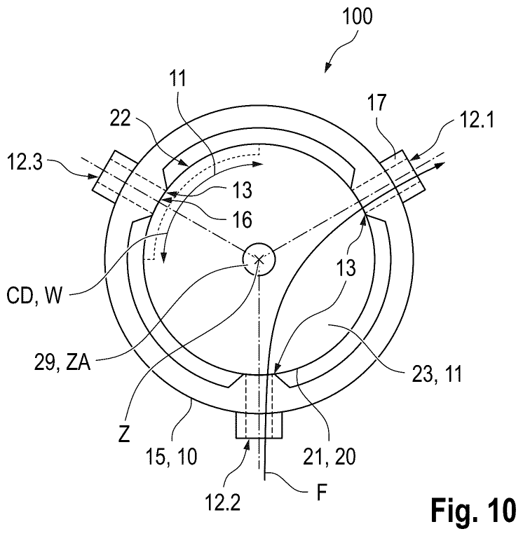

FIG. 10: shows a plan view of a multi-way valve with three connection openings including the rotary slide valve, and

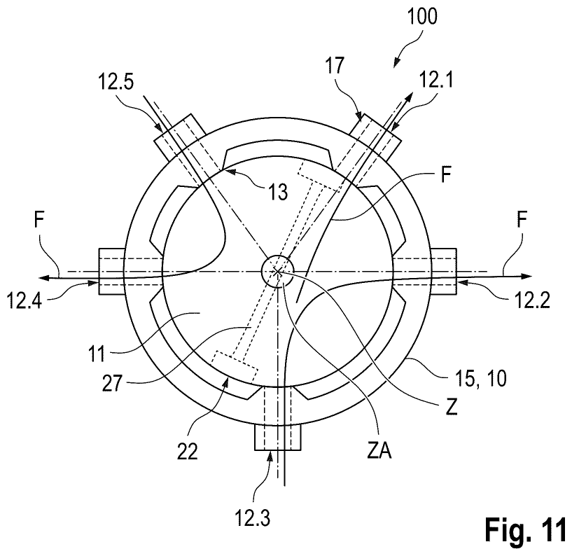

FIG. 11: shows a plan view of a multi-way valve with five connection openings including the rotary slide valve.

FIG. 1 shows a spatial view of a valve housing 10 for a multi-way valve 100, as shown, for example, in FIG. 10, having three connection openings 12.1, 12.2, 12.3. In this instance, the valve housing 10 is formed in a circular, cylindrical manner with respect to a central axis Z. In this embodiment, the central axis Z and the central region ZA are identical and/or the central region ZA is a concentric circular cylinder about the central axis Z, for example, with the radial extent of the bearing receiving member 18 shown. The valve housing 10 comprises a pot 15 having the connection openings 12.1, 12.2, 12.3 and a cover 14 which is shown here with broken lines and which has a bearing receiving member 18 for a bearing device 28 of a complementary rotary slide valve 20 (cf. FIG. 4 to FIG. 7). A housing space 11 in which in this instance three projections 13 protrude inward in each case in the region of a connection opening 12.1, 12.2, 12.3 is surrounded by the valve housing 10 or the pot 15 thereof. The projections 13 have, in this instance orientated in the direction toward the central axis Z, and in this instance additionally concentrically relative thereto a curved, more specifically a circular circle-segment-like counter-face 16 for sealing abutment with a complementary sealing face 22 of a rotary slide valve 20. Of the counter-faces 16, in this instance, purely for the sake of clarity, pars-pro-toto only the back right, that is to say the first connection opening 12.1, is provided in this view with a reference numeral. By means of the projections 13, in comparison with a continuous wall the contact phases, that is to say the phases which cause an increased torque, with the complementary sealing phase 22 are limited locally to what is necessary.

Nonethless, the connection openings 12.1, 12.2, 12.3 each have at the outer side, that is to say facing radially away from the central axis Z, a connection projection 17 which is configured for simple assembly or connection to a line. These connection projections 17 are preferably formed integrally with the remaining pot 15 of the valve housing 10, for example, by means of injection-molding. Of the connection projections 17, in this instance merely for the sake of clarity pars-pro-toto only the front one, that is to say the second connection opening 12.2, is provided in this view with a reference numeral.

The cover 14 of the valve housing 10 is in this instance formed separately from the pot 15 so that a sliding member 21 can be introduced along the central axis Z into the housing space 11, that is to say can be easily assembled.

The pot 15 has in this instance centrally purely optionally another bearing receiving member 18 for a rotary slide valve 20.

FIG. 2 shows a spatial view of a valve housing 10 having four connection openings 12.1, 12.2, 12.3, 12.4. Furthermore, without a generalization being excluded purely for the sake of clarity, the embodiment shown is identical to the embodiment according to FIG. 1 so that reference may be made in this regard to the description at that location. In contrast, precisely four connection elements 12.1, 12.2, 12.3, 12.4 which purely optionally are regularly spaced apart from each other by 90° in the rotation direction CD are provided.

FIG. 3 shows a plan view of a valve housing 10 for a multi-way valve 100, as shown, for example, in FIG. 11, with five connection openings 12.1, 12.2, 12.3, 12.4, 12.5. Furthermore, without a generalization being excluded purely for the sake of clarity, the embodiment shown is identical to the embodiment according to FIG. 1 and FIG. 2 so that reference may be made in this regard to the description at that location. In contrast, precisely five connection openings 12.1, 12.2, 12.3, 12.4, 12.5 are provided at this location, of which purely optionally generally the first connection opening 12.1 is spaced apart from the second connection opening 12.2 and the second connection opening 12.2 is spaced apart from the third connection opening 12.3 in the rotation direction CD by 90° in each case. The remaining connection openings 12.1, 12.3, 12.4, 12.5 are spaced apart from each other in the rotation direction CD by 60° in each case.

FIG. 4 shows a spatial view of a rotary slide valve 20 with a closure angle W of 120° in the rotation direction CD with respect to the central axis Z. The rotary slide valve 20 is in this embodiment purely optionally formed in a circular cylindrical manner and concentrically with respect to the central axis Z. This shape can be freely changed for respective requirements, for example, oval, eccentric, angular or a free form. The shape in this instance is also not intended to be formed so as to correspond directly to the shape of the valve housing 10 (cf., for example, FIG. 1 to FIG. 3). The only important matter is that, according to requirements, a sealing face 22 of the rotary slide valve 20 and an associated counter-face 16 of the corresponding valve housing 10 must be configured to be complementary, that is to say sealing for the desired states. In this instance, purely for better understanding a simple complementary circular form is illustrated, wherein the sealing faces 22 are formed to complement the counter-faces 16 in the regions in the connection openings 12.1, 12.2, 12.3, 12.4, 12.5, that is to say, for example, in the embodiments according to FIG. 1 to FIG. 3 to the counter-faces 16 formed by the projections 13, as a circular cylindrical curved segment face. The in this instance two sealing faces 22, wherein the rear one is concealed, extend over a closure angle W in the rotation direction CD with respect to the central axis Z. With the front visible sealing face 22, the closure angle W extends purely by way of example over 120° of 360°, preferably also the concealed sealing face 22. In the rotation direction CD between the sealing faces 22, in each case an opening, that is to say two openings 25, 26, are formed so that in this instance there is formed a single throughflow channel 23 through which in a corresponding relative orientation, that is to say a relative rotation angle, to at least two connection openings 12.1, 12.2 according to the indicated flow path F a fluid, for example, a gas or a liquid can flow.

For example, the illustrated rotary slide valve 20 is formed integrally by means of injection-molding with two plastics material components C1, C2, wherein the sliding member 21 is formed by a first plastics material component C1, for example, a fiber-reinforced thermoplastic, and the sealing face 22 is formed by a second plastics material component C2, for example, an thermoplastic elastomer (TPE), that is to say it can be configured to be softer.

It should be noted that it is in principle also possible for only one sealing face 22 to be provided, for example, like the sealing face 22 which can be seen here.

FIG. 5 shows a spatial view of a rotary slide valve 20 having a closure angle of 90° in the rotation direction CD with respect to the central axis Z. Furthermore, without a generalization being excluded, purely for the sake of clarity the embodiment shown is identical to the embodiment according to FIG. 4 so that in this regard reference may be made to the description at that location. In contrast thereto, the closure angle W is in this instance 90° of 360°.

FIG. 6 shows a spatial view of the rotary slide valve 20 according to FIG. 5 in comparison with the illustration therein rotated through 90° with respect to the central axis Z so that the throughflow channel 23 can be clearly seen, wherein the rear concealed opening 26 is illustrated by means of broken lines. In this instance, in addition another possible flow path F is shown, that is to say of two connection openings with the front opening 25 and also with two connection openings at the rear opening 26, but which are not illustrated in this instance. Consequently, a state is shown that at the front opening 25 two separate fluid flows according to the flow path F shown flow in and are mixed, and at the rear opening 26 they separate again over two separate fluid flows according to the flow path F shown.

FIG. 7 shows a plan view of a rotary slide valve 20 having two throughflow channels 23, 24. Furthermore, without a generalization being excluded, purely for the sake of clarity, the embodiment shown is identical to the embodiment according to FIG. 4 so that in this regard reference may be made to the description at that location. In contrast, precisely two throughflow channels 23, 24, which are fluidically separated from each other by means of a central partition wall 27, are provided so that in a corresponding state the separate flow path F shown can be adjusted. It should be noted that the flow direction is in this instance arbitrary, for example, it may also be configured to be in an opposing direction. Furthermore, one of the throughflow channels 23, 24 may also be closed, for example, by at least one of the two openings 25, 26 of the relevant throughflow channel 23, 24 not being positioned with respect to a connection opening. Furthermore, it may often be advantageous but not necessary for the throughflow channels 23, 24 to be constructed to be identical and/or inverted. The sealing faces 22 or the closure angle W (cf. FIG. 4 to FIG. 6) are larger or smaller than illustrated here and/or can be carried out with different dimensions.

Preferably, a lower-side or cover-side connection plate, as illustrated in FIG. 4 to FIG. 6 at the top and bottom, is illustrated to be transparent in this instance. Alternatively, one is provided only at one side and therefore the wall paths of the throughflow channels 23, 24 shown are illustrated with broken lines.

FIG. 8 shows a schematic view of a portion of a base face of a rotary slide valve 20 in the region of the sealing face 22 with material, which is connected to the sliding member 21 in a non-positive-locking manner, of the sealing face 22. The material from which the sliding member 21 is formed is, for example, a first plastics material component C1 or a metal component. In this portion of the sliding member 21, a recess R for the material from which the sealing face 22 of the rotary slide valve 20 is formed is provided. This second material is formed by a second plastics material component C2, for example, inserted or clip-fitted into the recess R and in this instance resiliently deformed. The second plastics material component C2 is, for example, an elastomer material.

FIG. 6 shows a schematic view of a portion of a base face of a rotary slide valve 20 in the region of the sealing face 22 with material, which is connected in a positive-locking and/or materially engaging manner to the sliding member 21, of the sealing face 22. Furthermore, without a generalization being excluded, purely for the sake of clarity the embodiment shown is identical to the embodiment according to FIG. 8 so that in this regard reference may be made to the description at that location. In contrast, the second material is only connected in a positive-locking and/or materially engaging manner and, for example, with a play, inserted into the recess R. For example, the second material is fixed in the recess R by means of adhesive bonding or vulcanization.

FIG. 10 shows a plan view of a multi-way valve 100 having three connection openings 12.1, 12.2, 12.3, for example, according to FIG. 1, with an inserted rotary slide valve 20, which in this instance has a single sealing face 22. By means of the single sealing face 22, together with the complementary counter-face 16 of the projection 13 at that location, the third connection opening 12.3 is closed in a fluid-tight manner, for example, with a multi-way valve 100 for a liquid, in a state sealed with respect to the introduction of a liquid, but not sealed with respect to the introduction of a gas. For example, a sealing is also achieved only from a predeterminedly low viscosity. Nonetheless, for example, a seal is then considered to be provided when a penetration of a fluid which is intended to be blocked is possible but can be disregarded or is not disruptive for the desired control behavior. It should be noted that it is not excluded that such a multi-way valve 100 or the sealing face 22 and a complementary counter-face 16 in the technical sense can be configured to be sealed.

In the state shown, a single throughflow channel 23 is formed between the first connection opening 12.1 and the second connection opening 12.2 so that the flow path F shown can be adjusted with any flow direction or a flow direction based on operation. By rotating the rotary slide valve 20 about the central axis Z, any one of the connection openings 12.1, 12.2, 12.3 or with a suitable expansion of the closure angle W of the sealing face 22 also two of them and consequently as a result all of the connection openings 12.1, 12.2, 12.3 can be closed at the same time. Preferably for good stability of the rotary slide valve 20 or the sliding member 21 in the central region ZA and/or at least at one other location a support column 29 is formed.

FIG. 11 shows a plan view of a multi-way valve 100 having a valve housing 10 having five connection openings 12.1, 12.2, 12.3 as shown, for example, in FIG. 3, together with the rotary slide valve 20, as shown, for example, in FIG. 7. Furthermore, without a generalization being excluded, purely for the sake of clarity the embodiment shown is identical to the embodiment according to FIG. 10 so that reference may be made in this regard to the description at that location. In contrast, precisely five connection openings 12.1, 12.2, 12.3, 12.4, 12.5 and a rotary slide valve 20 with two throughflow channels 23, 24 which are separated by means of a partition wall 27, that is to say separate, are provided. In this instance, a state is shown in which the fourth connection opening 12.4 and the fifth connection opening 12.5 are connected to each other in communication, but are closed with respect to the other connection openings 12.1, 12.2, 12.3 so that the flow path F shown at that location can be adjusted. Furthermore, the first connection opening 12.1 to third connection opening 12.3 are connected to each other in communication so that the flow path F which is shown here and which splits or which is mixed with a reverse flow direction can be adjusted. This is achieved by the partition wall 27 being provided and the sealing faces 22 in each case being in sealing abutment at the end side of the partition wall 27 with the counter-faces 16 of the projections 13 of the first connection opening 12.1 and opposite in the third connection opening 12.3, whilst the remaining sealing faces 22 in this state have no sealing function.

Regardless of the fact that the prior art affords many solutions, current multi-way valves 100 have some disadvantages: for example, no sealing elements are provided or corresponding sealing elements lead to a more complex assembly and/or the sealing elements require a separate production and consequently the entire evaluation from tool release until protype approval is necessary. Furthermore, sealing elements from the prior art are often only inadequately protected against wear. That is to say that in the valve housing 10 of the multi-way valve 100 the rotary slide valve 20 is incorporated and constantly has to rotate during function changes and furthermore, during the floating support of the seal, it can lead to significant differences for the torque. Furthermore, current solutions are configured in such a manner that the sealing element is located in the installed state between the housing and rotary slide valve 20 and thus has to ensure its function. With such an assembly, an infiltration of transported medium (fluid, paste, gel, etcetera) can take place very quickly in the separation plane between the housing and sealing element and can consequently have a negative effect on the operability. Furthermore, the sealing element is not securely connected to the housing and can thereby be moved in an uncontrolled manner in the x-axis, y-axis and z-axis, which in turn can have a negative effect on the operability. Furthermore, nowadays sealing material with better wear resistance is required in order to reduce negative influences on the operation.

These disadvantages are overcome with the present invention by a new sealing concept for a multi-way valve 100 and the multi-way valve 100, which can be produced in a simple manner and ensures reliable sealing with adequate mechanical durability, itself being provided. Furthermore, a multi-way valve 100 with reduced torque and less contact at the respective sealing location (sealing face) during the open position and the closed position compared with known solutions is proposed, wherein the multi-way valve 100 can fully perform the function.

The invention disclosed here relates to a multi-way valve 100, comprising a valve housing 10 in which at least two connection openings 12.1, 12.2, 12.3, 12.4, 12.5 or connections for fluid lines and at least one forward flow connection, also referred to simply as an inlet, and at least one return flow connection, also referred to simply as an outlet are provided. Furthermore, within the valve housing 10 between the forward and return flow connections, there is arranged a rotary slide valve 20 on which the sealing elements are fitted or in which the sealing elements are integrated. As a result of the rotation, the rotary slide valve 20 with the integrated sealing element is introduced at the connection opening 12.1, 12.2, 12.3, 12.4, 12.5 and thus has the sealing function. The valve housing 10 contains in an advantageous embodiment at one side an assembly opening for the rotary slide valve 20, wherein the assembly opening is closed in a sealed manner, for example, by means of a closure element which is releasably connected to the valve housing 10. In principle, the function of the multi-way valve 100 is completely performed by this invention, wherein the production costs can be reduced. Furthermore, a better reproducibility of the function can be achieved or a lower level of wear on the surface of the sealing element can be achieved, that is to say the sealing face 22, during ageing. The proposed concept is also advantageous with a more complex application.

With this multi-way valve 100, it is possible to control a plurality of external flow channels of a system with, for example, a plurality of fluid circuits in a manner which is simple in terms of structure and circuit technology. It is consequently possible to save a plurality of conventional multi-way valves 100 and to replace them with only a single multi-way valve 100. Furthermore, the assembly complexity is simplified, reduced and costs can thereby be reduced.

### LIST OF REFERENCE NUMERALS

100 Multi-way valve
10 Valve housing
11 Housing space
12.1 First connection opening
12.2 Second connection opening
12.3 Third connection opening
12.4 Fourth connection opening
12.5 Fifth connection opening
13 Projection
14 Cover
15 Pot
16 Counter-face
17 Connection projection
18 Bearing receiving member
20 Rotary slide valve
21 Sliding member
22 Sealing face
23 First throughflow channel
24 Second throughflow channel
25 First opening
26 Second opening
27 Partition Wall
28 Bearing device
29 Support column
F Flow path
R Recess
W Closure angle
Z Central axis
CD Rotation direction
ZA Central region
C1 First plastics material component
C2 Second plastics material component

1-10. (canceled)

11. A multi-way valve for controlling a flow of a fluid, the multi-way valve comprising:
a valve housing formed with a housing space having a central axis;
said valve housing being formed with at least three separate connection openings which are oriented relative to at least one of the central axis or a central region of said housing space;
a rotary slide valve configured for insertion into said housing space and for rotation about the central axis;
said rotary slide valve having a sliding member and at least one sealing face, with said sealing face being formed of a material that is softer than a material of said sliding member; and
said rotary slide valve being configured to set at least one given state in which at least two of said connection openings are connected in communication while at least one of said connection openings is closed relative to said connection openings that are connected in communication, and a different state that is different from the at least one given state.

12. The multi-way valve according to claim 11, wherein said valve housing is formed, in a region of each of said connection openings, with a projection directed toward at least one of the central axis or said central region of said valve housing.

13. The multi-way valve according to claim 11, wherein said valve housing is formed with a pot and a cover, and said rotary slide valve is configured for introduction into said pot along a linear path for assembly of the multi-way valve.

14. The multi-way valve according to claim 11, wherein said rotary slide valve has at least two separate throughflow channels formed therein.

15. The multi-way valve according to claim 11, wherein said connection openings are arranged cylindrically with respect to the central axis of said valve housing and angularly spaced apart from each other in a rotation direction.

16. The multi-way valve according to claim 11, wherein said at least one sealing face has a size and arrangement to enable one of said connection openings to be closed exclusively with said at least one sealing face.

17. The multi-way valve according to claim 11, wherein said at least one sealing face is one of a plurality of sealing faces and wherein one of said sealing faces has a size and arrangement for closing off at least one or more of said connection openings with the one sealing face alone.

18. The multi-way valve according to claim 11, wherein said sliding member of said rotary slide valve and said valve housing are formed from the same material.

19. The multi-way valve according to claim 11, wherein the relatively softer material of said at least one sealing face of said rotary slide valve is a rubber-elastic material.

20. The multi-way valve according to claim 11, wherein said rotary slide valve is an injection-molded part, with the material of said sliding member being formed of a first plastics material component and the material of said sealing face being formed of a second plastics material component.

21. The multi-way valve according to claim 11, wherein the material of said sealing face is connected to said sliding member by a connection selected from the group consisting of a positive-locking connection, a non-positive-locking connection, adhesive bonding, welding, spraying-on, and vulcanization.
